(19) United States
(12) Patent Application Publication
(10) Pub. No.: US 2026/0285493 A1
(43) Pub. Date: Sep. 24, 2026

(54) AIRCRAFT TURBOMACHINE PROPELLER COMPRISING A SYSTEM FOR AUTONOMOUS SUPPLY OF HEATING MEMBERS FOR DE-ICING AND ASSOCIATED METHOD

(71) Applicant: SAFRAN ELECTRICAL & POWER, BLAGNAC (FR)

(72) Inventor: Djemouai HADJIDJ, MOISSY-CRAMAYEL (FR)

(73) Assignee: SAFRAN ELECTRICAL & POWER, BLAGNAC (FR)

(21) Appl. No.: 19/151,829

(22) PCT Filed: Jan. 17, 2024
(86) PCT No.: PCT/EP2024/051058

§ 371 Date: Jul. 29, 2025

(30) Foreign Application Priority Data
Feb. 6, 2023 (FR) FR2301083

(51) Int. Cl. B64D 33/02; B64D 31/00; B64D 41/00; F01D 15/10; H02K 7/18; H02K 7/20; H02K 21/14

(52) U.S. Cl. CPC B64D 33/02; B64D 31/00; B64D 41/00; F01D 15/10; H02K 7/1823; H02K 7/20; H02K 21/14; B64D 2033/0233

(57) ABSTRACT

The invention relates to an aircraft turbomachine propeller comprising a cone extending axially along an axis (X) and blades, the propeller being configured to be rotated by a shaft of the turbomachine (A), the propeller comprising a plurality of heating members (2) and a power supply system (3) for supplying power to the heating members (2), the power supply system (3) being mounted in the cone and configured to autonomously generate electrical power from the rotation of the shaft of the turbomachine (A).

### TECHNICAL FIELD The present invention relates to the de-icing of a propeller of an aircraft turbomachine.

In a known manner, an aircraft comprises one or more turbomachines to allow the propulsion. A turbomachine comprises at least one rotating shaft configured to drive a propeller in rotation, in particular via a speed reduction gear known to those skilled in the art as an RGB (Reduction Gear Box). In a known way, a propeller comprises an axially extending cone from which a plurality of radial vanes extend.

During the flight of the aircraft, ice is likely to form on the propeller blades. To remove it, it is known to equip the propeller blades with a plurality of heating members. In a known way, a heating member takes the form of a heating mat comprising a plurality of resistors which are positioned on the leading edge of the vane but also on the cone. In icy conditions, the heating members are activated intermittently to break up the layers of ice. The layers of ice are then ejected by the centrifugal force of the propeller rotation.

The heating members are electrically supplied, and a high electrical power rating is required in order to de-ice the propeller effectively. The electrical power is supplied to the de-icing system by an electrical source internal to the aircraft or the turbomachine. In practice, the electrical source is positioned in a stationary reference frame, while the heating members are positioned in a rotating reference frame linked to the blades. To enable the energy to be transferred, a rotating transformer is required. The rotating transformer is connected to an electrical source via power harnesses. The installation of power supply harnesses from the electrical source to the transformer is complex and increases the weight and overall dimension of the turbomachine. This is particularly detrimental during maintenance operations. In addition, routing the power harnesses through several parts of the turbomachine is problematic, as they require bending radii that are often unfeasible given the limited overall dimension.

The invention aims to eliminate at least some of these disadvantages by proposing a system for supplying heating members which is simple to install and maintain while having a reduced weight and volume.

### SUMMARY

The invention relates to an aircraft turbomachine propeller comprising a cone extending axially along an axis and blades, the propeller being configured so as to be driven in rotation by a shaft of the turbomachine, the propeller comprising a plurality of heating members and a power supply system for supplying power to the heating members.

The invention is remarkable in that the power supply system is mounted in the cone and configured so as to generate electrical energy autonomously from the rotation of the shaft of the turbomachine.

Thanks to the invention, it is not necessary to provide a power supply harness, which limits the weight and bulk of the power supply system. Furthermore, since the power supply system is autonomous, there is no need for time-consuming connection steps with power supply harnesses, and the power supply system can be conveniently replaced. Mounting in the cone is advantageously accessible. Advantageously, this allows a de-icing to be carried out without taking into account the aircraft's main electrical sources, which has advantages for their design by limiting the integration constraints between the turbomachine and the aircraft.

Advantageously, the electrical energy is generated directly in a rotating reference frame secured to the cone, which allows the use of a converter to be dispensed with.

According to one aspect, the power supply system comprises a permanent magnet synchronous generator configured to generate electrical power autonomously from the rotation of the shaft of the turbomachine. A generator of this type is used to generate an electric current to power the heating members.

According to one aspect, the permanent magnet synchronous generator comprises a first stator fulfilling an inductor function and a first rotor fulfilling an armature function, the first rotor being secured to rotation to the shaft of the turbomachine. So, unlike a traditional permanent magnet synchronous generator, the first stator functions as the inductor rather than the first rotor. This allows an electrical current to be generated directly in the first rotor in order to supply the heating members directly in the rotating reference frame. It is advantageous to dispense with a rotating transformer that requires an alternative electrical source and harnesses to carry the electrical supply to the transformer. Preferably, the first stator functions as a magnet inductor.

Preferably, the first rotor extends radially outside of the first stator. This allows the heating elements located at the outer periphery of the propeller to be supplied as closely as possible.

According to one aspect, the armature is positioned radially on the outside and the inductor (magnets) is positioned radially on the inside.

According to one aspect, the power supply system comprises a single electrical machine, in particular only a permanent magnet synchronous generator.

According to one aspect, the power supply system comprises an electrical supply machine comprising a second stator fulfilling an inductor function and a second rotor fulfilling an armature function, the second rotor being secured in rotation to the shaft of the turbomachine, the second stator being supplied by the permanent magnet synchronous generator. Preferably, the second stator is wound.

A two-stage power supply system advantageously avoids the use of a converter rotating in the rotating reference frame. The electrical supply machine supplies a supply current directly to the heating members. The electrical supply machine has a wound inductor and requires a power supply to become autonomous.

According to one aspect, the second rotor extends radially outwards from the second stator. This allows the energy supply to the rotating reference frame to be synchronized naturally and the heating members located on the outer periphery of the propeller to be supplied as closely as possible.

According to one aspect, the second stator is supplied by the first stator of the permanent magnet synchronous generator.

According to one aspect, the power supply system comprises a control computer configured to convert the supply current supplied by the permanent magnet synchronous generator as a function of the current supplying the heating members. Preferably, the control computer supplies power directly to the second stator. In this case, the control computer preferably belongs to the stationary reference frame.

According to one aspect, the electrical supply machine is positioned downstream of the permanent magnet synchronous generator. This allows the overhang to be limited by positioning the heaviest equipment downstream.

According to one aspect, the power supply system comprises an excited electrical machine comprising a third stator fulfilling an inductor function and a third rotor fulfilling an armature function, the third rotor being secured in rotation to the shaft of the turbomachine, the third stator being supplied by the permanent magnet synchronous generator, the first rotor supplying the excited electrical machine which supplies the electrical supply machine so as to form a three-stage power supply system. In other words, the power supply system comprises three generators in cascade that share a fixed shaft and a rotating shaft.

According to one aspect, the excited electrical machine is positioned upstream of the electrical supply machine, preferably downstream of the permanent magnet synchronous generator. This allows the overhang to be limited by positioning the heaviest equipment downstream.

According to one aspect, the third rotor extends radially outside of the third stator.

According to one aspect, the propeller comprises a stationary reference frame and a rotating reference frame secured in rotation to the cone, each rotor belonging to the rotating reference frame while each stator belongs to the stationary reference frame.

According to one aspect, the power supply system comprises a control computer configured to convert the supply current supplied by the permanent magnet synchronous generator as a function of the current supplying the heating members.

According to one aspect, the power supply system comprises a de-icing controller configured to provide the control computer with a power command, the control computer being configured to convert the supply current supplied by the permanent magnet synchronous generator as a function of the current supplying the heating members and the power command.

According to one aspect, the control computer is supplied by the first rotor of the permanent magnet synchronous generator, and the third rotor is supplied by the control computer. In this case, the control computer should preferably belong to the rotating reference frame.

According to one aspect, the power supply system comprises an electrical switch connected to a plurality of heating members. The power supply system thus ensures generation and distribution. A sequential control allows the size of the power supply system to be limited and allows it to be mounted in the cone. Preferably, the electrical switch is secured to the rotating reference frame.

Advantageously, the integration of an electrical switch in the power supply system allows all the functions related to heating to be combined within the same equipment, which facilitates installation and maintenance.

According to one aspect, the de-icing controller is configured to provide the electrical switch with a sequence command in order to control a sequential supply of power to the heating members.

According to one aspect, the propeller comprises at least one speed reduction gear mounted between the turbomachine shaft and the cone. This allows the power supply system to take advantage of the reduction gear bearings without integrating bearings specific to the power supply system. This allows the air gap in the electrical machines to be limited, thereby improving generation reliability. It goes without saying, however, that the power supply system could include its own bearings.

According to one aspect, the heating members are resistive.

The invention further relates to a method of using a propeller as hereinbefore presented, comprising steps consisting of:
driving the turbomachine shaft in rotation to drive the blades in rotation and
generating electrical energy from the rotation of the turbomachine shaft so as to supply electrical power to the heating members in order to de-ice the propeller.

### BRIEF DESCRIPTION OF THE DRAWINGS

The invention will be better understood on reading the following description, given by way of example, with reference to the following figures, given by way of non-limiting examples, wherein identical references are given to similar objects.

FIG. 1 is a schematic representation of a propeller with a system for supplying electrical power to the heating members according to the invention.

FIG. 2 is a schematic representation of a first embodiment of a power supply system.

FIG. 3 is a schematic representation of a second embodiment of a power supply system.

FIG. 4 is a schematic representation of a third embodiment of a power supply system.

It should be noted that the figures set out the invention in detail in order to implement the invention, said figures of course being able to be used to better define the invention if necessary.

### DETAILED DESCRIPTION

The invention will be presented for an aircraft comprising a plurality of propeller-driven turbo-engines for propelling the aircraft, in particular, a plurality of turboprop engines.

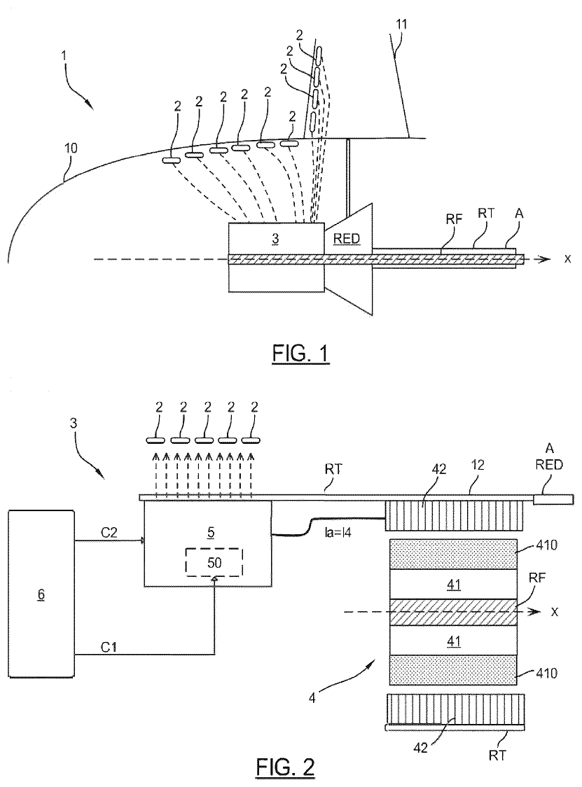

With reference to FIG. 1, an aircraft turbomachine propeller 1 is shown schematically. The propeller 1 comprises a cone 10, extending axially along an axis X, oriented from upstream to downstream in FIG. 1, and blades 11 which extend, in this example, radially with respect to the axis X.

The propeller 1 is configured to be rotated by a shaft of the turbomachine A in order to rotate the blades 11 and generate propulsion work. Preferably, as illustrated in FIG. 1, the propeller 1 comprises a speed reduction gear RED mounted between the shaft of the turbomachine A and the cone 10 in order to modify the speed ratio. The propeller 1 comprises a stationary reference frame RF and a rotating reference frame RT which is integral in rotation to the cone 10.

The propeller 1 comprises a plurality of heating members 2 to enable the de-icing of the propeller 1. In a known way, a heating member 2 takes the form of a heating mat comprising a plurality of resistors which are positioned on a leading edge of a blade 11 and on the cone 10. In the presence of icing conditions, the heating members 2 are activated intermittently to loosen the layers of ice. The layers of ice are then ejected due to the centrifugal force associated with the rotation of the propeller 1. With reference to FIG. 1, the propeller 1 comprises a power supply system 3 for supplying power to the heating members 2.

According to the invention, the power supply system 3 is mounted in the cone 10 of the propeller 1 and is self-contained. By autonomous, we mean that the power supply system 3 generates electrical energy solely from the mechanical torque supplied by the shaft of the turbomachine A without recourse to an external source as in the prior art. This has the advantage of eliminating power supply harnesses, which increase weight, bulk, and complexity. The power supply system 3 can be maintained and replaced quickly and easily.

According to one aspect of the invention, with reference to FIG. 2, the power supply system 3 comprises a permanent magnet synchronous generator 4 configured to generate electrical energy autonomously from the rotation of the shaft of the turbomachine A. The permanent magnet synchronous generator 4 comprising a first stator 41 fulfilling an inductor function and a first rotor 42 fulfilling an armature function, the first rotor 42 being fixed in rotation to the shaft of the turbomachine A. This advantageously allows an electric current l4 to be generated at the first rotor 42 to supply the heating members 2.

According to a first embodiment, with reference to FIG. 2, the power supply system 3 comprises an electrical switch 5 connected to a plurality of heating members 2. Advantageously, the electrical switch 5 controls the sequential power supply to the heating members 2.

In this first embodiment, the electrical switch 5 is supplied directly by the permanent magnet synchronous generator 4. In the following, the current supplying the electrical switch 5 is referred to as the “supply current la”.

In this example, the electrical switch 5 is supplied directly by the first rotor 42 of the permanent magnet synchronous generator 4 (la=14). According to one aspect, the power supply system 3 comprises a single electrical machine which is the permanent magnet synchronous generator 4.

Preferably, the electrical switch 5 also comprises an electrical converter 50, in particular an active (controlled) rectifier, in order to convert the supply current la into direct current. For the sake of clarity and brevity, the electrical converter is not shown in all embodiments of the invention. It is shown in FIG. 2 to convert the current from the permanent magnet synchronous generator 4. As shown in FIG. 2, the electrical switch 5 is connected to the rotating reference frame RT to supply power to the heating members 2. Depending on the architecture, it goes without saying that an electrical converter is optional and that electrical switch 5 could be supplied directly by alternating current. The electrical converter could also be passive (uncontrolled) and take the form of a diode bridge, for example.

Still referring to FIG. 2, the power supply system 3 further comprises a de-icing controller 6 configured to define the de-icing strategy, in particular, a power command C1 and a sequence command C2 which are transmitted to the electrical switch 5. In this example, the electrical switch 5 comprises a power converter 50 which receives the power command C1 to set the desired power.

The first rotor 42 of the permanent magnet synchronous generator 4 belongs to the rotating reference frame RT while the first stator 41 of the permanent magnet synchronous generator 4 belongs to the stationary reference frame RF. In this example, the first rotor 42 and the electrical switch 5 are connected to a rotating housing 12. The permanent magnet synchronous generator 4 is of the “inverted” type since the first rotor 42 extends radially outside the first stator 41 with respect to the axis X. As illustrated in FIG. 2, the permanent magnet synchronous generator 4 comprises a plurality of magnets 410 at the periphery of its first stator 41. This type of architecture enables the supply of electrical energy to be naturally synchronised with the rotating reference frame RT without the need for additional devices such as a rotating transformer in the prior art.

Such a power supply system 3 is advantageous because it requires little equipment and is easy and practical to maintain. Advantageously, the power supply system 3 is autonomous. When the turbomachine shaft A rotates, the rotating housing 12 is also driven, preferably via the reduction gear RED.

The rotation of the first rotor 42 of the permanent magnet synchronous generator 4 allows an induced current l4 to be generated by magnetic interaction with the magnets 410 of the first stator 41, which belongs to the stationary reference frame RF.

The induced current l4 corresponds to the supply current la of the electrical switch 5. The de-icing controller 6 issues a power command C1 and a sequence command C2 to the electrical switch 5, which is used to define the control strategy for the heating members 2, i.e. the power and de-icing delay.

Thanks to the invention, it is not necessary to provide a passage for feeding harnesses. The power supply system 3 is autonomous and independent. This makes the de-icing members independent of the aircraft's generation and distribution system, which avoids oversizing and limits stress.

In this first embodiment, the permanent magnet synchronous generator 4 is associated with a power converter 50 controlled in the rotating reference frame RT to manage the level of power to be supplied to the heating members 2. This affects the reliability and availability of the power supply system 3. In this embodiment, the permanent magnet synchronous generator 4 must remain permanently active even in non-icing conditions, which increases the risk of fire and limits its service life.

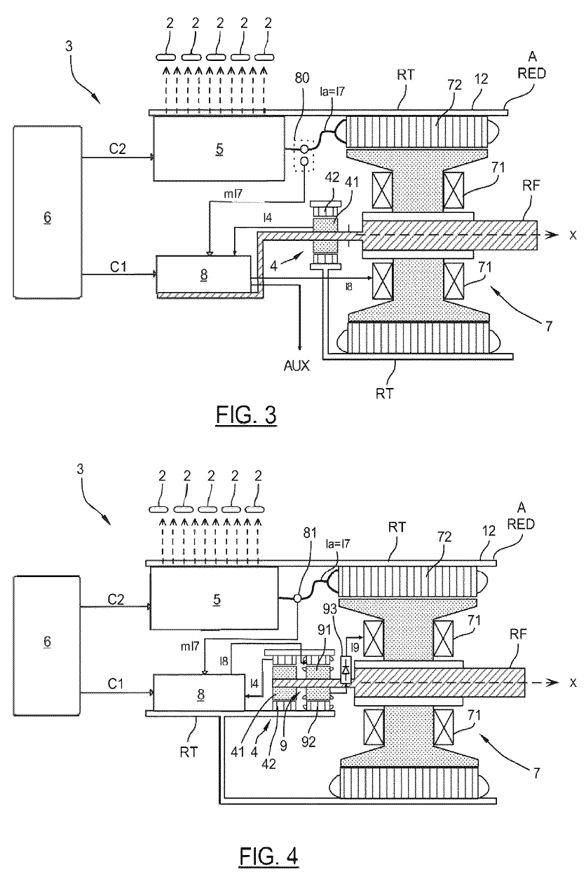

A second embodiment is shown in FIG. 3. For the sake of clarity and brevity, elements identical or similar to the first embodiment are not described again.

According to the second embodiment, with reference to FIG. 3, the power supply system 3 further comprises an electrical supply machine 7 comprising a second stator 71 performing an inductor function and a second rotor 72 performing an armature function. The second rotor 72 is secured in rotation to the shaft of the turbomachine A. The second stator 71 is supplied by the permanent magnet synchronous generator 4, in particular via the first stator 41.

A two-stage architecture advantageously allows the size of the permanent magnet synchronous generator 4 to be reduced, in particular by eliminating the power converter 50 shown in FIG. 2, which allows an overall reduction in the weight and size of the power supply system 3.

In order to control the power supply, the power supply system 3 further comprises a control computer 8. As shown in FIG. 3, the second stator 71 is supplied indirectly by the permanent magnet synchronous generator 4 via the control computer 8.

As illustrated in FIG. 3, the permanent magnet synchronous generator 4 generates an alternating current l4 in the first stator 41 which is transformed by the control computer 8 into a direct current l8 to supply the second stator 71 and generate an alternating current l7 in the second rotor 72 in order to supply the electrical switch 5 (la=l7).

Since the first stator 41 and the second stator 71 belong to the stationary reference frame RF, it is advantageous to place the control computer 8 in the stationary reference frame RF as shown in FIG. 3. In this example, the control computer 8 comprises a rectifier-type electrical converter. Optionally, with reference to FIG. 3, the control computer 8 can also supply direct or alternating current to other auxiliary electrical loads AUX.

The control computer 8 is configured to receive the power command C1 from the de-icing controller 6 so as to accurately determine the current l8 to be supplied to the second stator 71.

According to one aspect, as illustrated in FIG. 3, the control computer 8 is connected to a current sensor 80 configured to measure the current l7 supplied by the second rotor 72 of the electrical supply machine 7. This advantageously allows the control computer 8 to determine the current 18 to be supplied to the second stator 71 by servo control based on the power command C1 and the supply current la (current l7 supplied by the second rotor 72).

Since the second rotor 72 belongs to the rotating reference frame RT and the control computer 8 belongs to the stationary reference frame RF, it is preferable to use a contactless inductive sensor 80. It goes without saying that the control computer 8 could measure any physical quantity (current or voltage) mirroring the current l7.

In this second embodiment, the permanent magnet synchronous generator 4 and the control computer 8 are dimensioned to supply excitation power directly to the electrical supply machine 7, i.e., approximately 1/10 th of the power of the heating members 2.

A third embodiment is shown in FIG. 4. For the sake of clarity and brevity, the elements identical or similar to the second embodiment are not described again.

According to the third embodiment, with reference to FIG. 4, the power supply system 3 further comprises an excited electrical machine 9 comprising a third stator 91 fulfilling an armature function and a third rotor 92 fulfilling an inductor function. The third rotor 92 is secured in rotation to the shaft of the turbomachine A.

The third rotor 92 is supplied by the permanent magnet synchronous generator 4, in particular via the first rotor 42. This kind of supply is practical because they all belong to the rotating reference frame RT.

In this example, the third rotor 92 of the excited electrical machine 9 is supplied indirectly by the first rotor 42 of the permanent magnet synchronous generator 4 via the control computer 8. As illustrated in FIG. 4, the permanent magnet synchronous generator 4 generates an alternating current l4 in the first rotor 42 which is transformed by the control computer 8 into direct current l8 to supply the third rotor 92.

The second stator 71 of the electrical supply machine 7 is supplied by the third stator 91 of the excited electrical machine 9 as shown in FIG. 4. Preferably, the third stator 91 of the excited electrical machine 9 generates an alternating current which is rectified via a rectifier 93 to supply the second stator 71 of the electrical supply machine 7 with a direct current l9. In this example, the rectifier 93 is in the form of a diode bridge. The electrical supply machine 7 generates an alternating current l7 in the second rotor 72 to supply the electrical switch 5 (la=l7).

A three-stage architecture allows for a significant reduction in the overall size and weight of the power supply system. With this architecture, the permanent magnet synchronous generator 4 and the excited electrical machine 9 are small in size compared to the second embodiment of FIG. 3 (approximately 1/100 th of the power of the heating members 2).

In the first embodiment, the permanent magnet synchronous generator 4 is the main (and only) equipment that supplies electrical power to the heating members 2. In the second embodiment, the permanent magnet synchronous generator 4 is a secondary source of excitation for the electrical supply machine 7. The permanent magnet synchronous generator 4 supplies approximately 10% of the electrical power to the heating members 2. In the third embodiment, the permanent magnet synchronous generator 4 is also a secondary source of excitation for the electrical supply machine 7. The permanent magnet synchronous generator 4 supplies approximately 1% of the electrical power to the heating members 2.

Since the first rotor 42 and the third rotor 92 belong to the rotating reference frame RT, it is advantageous to place the control computer 8 in the rotating reference frame RT as shown in FIG. 4.

As before, the control computer 8 is configured to receive the power command C1 from the de-icing controller 6 so as to accurately determine the current l8 to be supplied to the third rotor 92.

According to one aspect, as illustrated in FIG. 4, the control computer 8 is connected to a current sensor 81 configured to measure the current l7 (ml7) supplied by the second rotor 72 of the electrical supply machine 7. This advantageously enables the control computer 8 to determine the current l8 to be supplied to the third rotor 92 by servo-control on the basis of the power command C1 and the measurement ml7 of the supply current la (current l7 supplied by the second rotor 72). Given that the third rotor 92 belongs to the rotating reference frame RT and that the control computer 8 belongs to the rotating reference frame RT, a conventional current sensor 81 can advantageously be used.

A three-stage power supply system 3 makes integration simple and practical to maintain, while saving weight and mass.

In order to ensure optimum cooling of the power supply system 3, several cooling devices may advantageously be provided. For example, a fan can be mounted in the cone 10 to cool the electrical equipment 4, 7, 9. The rotating housing 12 can also be fitted with cooling fins. Advantageously, the speed reduction gear comprises a cooling circuit, for example an oil circuit, which synergistically supplies a cooling circuit of the power supply system.

1-9. (canceled)

10. An aircraft turbomachine propeller comprising a cone extending axially along an axis and blades, the propeller being configured so as to be driven in rotation by a shaft of the turbomachine, the propeller comprising a plurality of heating members and a power supply system for supplying power to the heating members, the power supply system being mounted in the cone and configured so as to generate electrical energy autonomously from the rotation of the shaft of the turbomachine, the power supply system comprising a permanent magnet synchronous generator configured to generate electrical energy autonomously from the rotation of the shaft of the turbomachine, the permanent magnet synchronous generator comprising a first stator fulfilling an inductor function and a first rotor fulfilling an armature function, the first rotor being secured in rotation to the shaft of the turbomachine, the power supply system comprising:
an electrical supply machine comprising a second stator fulfilling an inductor function and a second rotor fulfilling an armature function, the second rotor being secured in rotation to the shaft of the turbomachine, the second stator being supplied by a permanent magnet synchronous generator.

11. The propeller according to claim 10 wherein the first rotor extends radially outside of the first stator.

12. The propeller according to claim 10 wherein the second rotor extends radially outwards from the second stator

13. The propeller according to claim 10, wherein the power supply system comprises an excited electrical machine comprising a third stator fulfilling an inductor function and a third rotor fulfilling an armature function, the third rotor being secured in rotation to the shaft of the turbomachine, the third stator being supplied by the permanent magnet synchronous generator, the first rotor supplying the excited electrical machine, which supplies the electrical supply machine so as to form a three-stage power supply system.

14. The propeller according to claim 10, comprising a stationary reference frame and a rotating reference frame secured in rotation to the cone, each rotor belonging to the rotating reference frame while each stator belongs to the stationary reference frame.

15. The propeller according to claim 10, wherein the power supply system comprises a control computer configured to convert the supply current supplied by the permanent magnet synchronous generator as a function of the current supplying the heating members.

16. The propeller according to claim 15, wherein the power supply system comprises a de-icing controller configured to provide the control computer with a power command, the control computer being configured to convert the supply current supplied by the permanent magnet synchronous generator as a function of the current supplying the heating members and the power command.

17. The propeller according to claim 10, wherein the power supply system comprises an electrical switch connected to a plurality of heating members.

18. A method of using a propeller according to claim 10, comprising the steps of:
driving the turbomachine shaft in rotation to drive the blades in rotation and generating electrical energy from the rotation of the turbomachine shaft so as to supply electrical power to the heating members in order to de-ice the propeller.
